(19) United States
(12) Patent Application Publication
(10) Pub. No.: US 2013/0038549 A1
(43) Pub. Date: Feb. 14, 2013

(54) INPUT DEVICE FOR TOUCH SCREEN AND TOUCH SCREEN SYSTEM HAVING THE SAME

(71) Applicants: Takashi KITADA, Fukuoka (JP); Taichi YAMADA, Fukuoka (JP)

(72) Inventors: Takashi KITADA, Fukuoka (JP); Taichi YAMADA, Fukuoka (JP)

(73) Assignee: PANASONIC CORPORATION, Osaka (JP)

(21) Appl. No.: 13/566,172

(22) Filed: Aug. 3, 2012

(30) Foreign Application Priority Data
Aug. 11, 2011 (JP) 2011-175914

(51) Int. Cl. G06F 3/041

(52) U.S. Cl. 345/173

(57) ABSTRACT

An input device for a touch screen includes: a supporter placed on a touch surface of a touch screen device; operation keys supported by the supporter and an operation thereon by a user is detected on the touch screen device side; and a conductor for input device identification that is conductible with a user's body and indicates an area in which the operation by the user is detected. In particular, the operation keys each have a conductor for body touch that comes in contact with the user's body when the user performs an operation. The conductor for body touch is electrically connected to a conductor for input device identification.

### CROSS-REFERENCE TO RELATED APPLICATIONS

The present application claims priority under 35 U.S.C. §119 of Japanese Application No. 2011-175914, filed on Aug. 11, 2011, which is herein expressly incorporated by reference in its entirety.

### BACKGROUND OF THE INVENTION

1. Field of the Invention

The present invention relates to an input device for a touch screen and a touch screen system having the same, the input device being placed and used on a touch surface of the touch screen device.

2. Description of Related Art

Touch screen devices are widely used as position input devices for inputting positions on screens. Although such touch screen devices provide good usability in performing screen operations such as an operation to select buttons on a screen, keyboards are required for text input. Since it is troublesome to prepare a separate keyboard and connect it to a PC, a touch screen device is generally used as a substitute for the keyboard. More specifically, a soft keyboard is displayed on a screen of a display, and a user inputs text by selecting keys using the touch screen device.

In relation to operating keys with a touch screen device, a technology is known in which a display panel arranged on a rear side of a touch screen is configured to be smaller than the touch screen, and a fixed display sheet on which operation keys are drawn is provided in a fixed display area formed outside a variable display area constituted by the display panel (see Related Art 1). In this technology, a touch screen device detects fingers pressing the operation keys drawn on the fixed display sheet and identifies an operation on the operation keys.

As described above, it is possible to configure an operation key type input device with a touch screen device by displaying a soft keyboard on a screen or by proving a touch screen with a fixed display sheet on which operation keys are drawn. In these conventional technologies, however, the position of the input device is fixed. Thus, the conventional technologies are not necessarily convenient for a user to use.

[Related Art 1] Japanese Patent Laid-open Publication No. H 11-312054

### SUMMARY OF THE INVENTION

The present invention has been devised in order to address the circumstances of the conventional technologies described above. A main advantage of the present invention is to provide an input device for a touch screen that is configured to enhance usability for a user, and a touch screen system having the same.

An input device for a touch screen of the present invention includes: a supporter provided on a touch surface of a touch screen device; and an operation member for an operation by a user. The operation member being supported by the supporter. The operation member includes a body touch conductor that comes into contact with the user's body when the user operates the operation member, and the supporter includes an input device identification conductor that indicates a touch area where the input device is placed on the touch surface. The body touch conductor is electrically connected to the input device identification conductor so that the touch screen device detects the input device identification conductor when the user operates the operation member.

According to the present invention, by causing the touch screen device to detect the conductor for input device identification, it is possible for the touch screen device side to detect a placement position of the input device on the touch surface. Accordingly, it is possible to place and use the input device in a desired position on the touch screen of the touch screen device. Therefore, usability for a user is improved.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a diagram illustrating an overall configuration of a touch screen system according to a first embodiment;

FIGS. 2A and 2B are perspective views illustrating examples of the touch screen system in use;

FIG. 3 is a plan view of a keyboard-type input device;

FIG. 4 is a cross-sectional view of the keyboard-type input device;

FIG. 5 is a cross-sectional view of a joystick-type input device;

FIG. 6 is a plan view of the joystick-type input device;

FIG. 7 is a functional block diagram illustrating a schematic configuration of a controller of a touch screen device 1;

FIGS. 8A and 8B are diagrams illustrating procedures to detect the input devices;

FIG. 9 is a flowchart illustrating steps of processing performed in the controller of the touch screen device;

FIG. 10 is a plan view of a touch screen system according to a second embodiment;

FIG. 11 is a cross-sectional view of a touch screen main body, a display panel main body, and an electrode plane;

FIG. 12 is an exploded perspective view of the touch screen main body, the display panel main body, and the electrode plane;

FIG. 13 is a plan view of the electrode plane;

FIGS. 14A and 14B are diagrams illustrating frequency characteristics of output signals of receiving electrodes; and

FIG. 15 is a cross-sectional view of another example of the keyboard-type input device.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereinafter, embodiments of the present invention are described with reference to drawings.

### First Embodiment

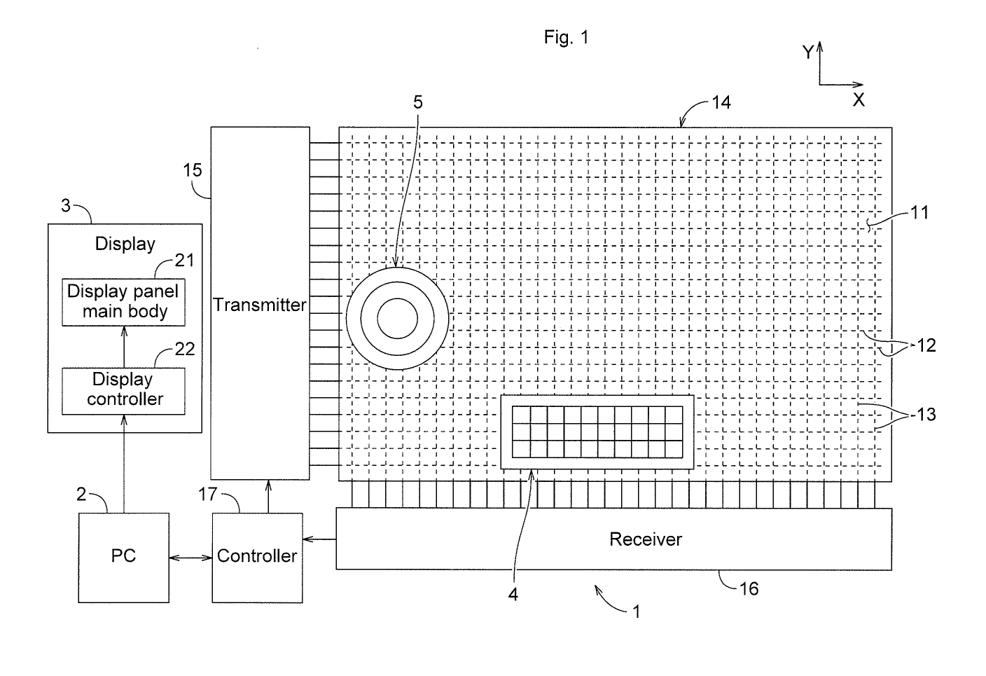

FIG. 1 is a diagram illustrating an overall configuration of a touch screen system according to a first embodiment. The touch screen system is configured with a touch screen device 1, a PC (information processing device) 2, a display 3, a keyboard-type input device 4, and a joystick-type input device 5.

The touch screen device 1 includes a touch screen main body 14. In order to detect a touch operation with a pointing object (a user's finger, a stylus, or the like), the touch screen main body 14 is provided with a plurality of transmitting electrodes 12, which are arranged in parallel to one another, and a plurality of receiving electrodes 13, which are arranged in parallel to one another, the transmitting electrodes 12 and the receiving electrodes 13 crossing in a grid pattern. A touch operation with a pointing object is performed on a touch surface 11 provided on a front surface of the touch screen main body 14.

A touch operation performed with a pointing object on the touch surface 11 is detected by the touch screen device 1. A signal including touch position information is then output to the PC 2. The PC 2 performs processing appropriate for a screen operation corresponding to the touch position, the screen operation being an operation to move a pointer (cursor) on the screen, an operation to select a button on the screen, an operation to draw a line, or the like.

In addition, the keyboard-type input device 4 and the joystick-type input device 5 may be provided on the touch surface 11. When a user operates these input devices 4 and 5, the user's operation is detected by the touch screen device 1. Accordingly, a signal similar to that of a general keyboard device or joystick device is output from the touch screen device 1 to the PC 2. The PC 2 performs processing, such as text input, based on the signal from the touch screen device 1.

The display 3 includes a display panel main body 21 and a display controller 22. The display panel main body 21 is configured with a plasma display panel, liquid crystal display panel, or the like. The display controller 22 controls a display operation of the display panel main body 21 based on display data output from the PC 2.

The touch screen device 1 includes a transmitter 15, a receiver 16, and a controller 17. The transmitter 15 applies a driving signal to the transmitting electrodes 12. The receiver 16 receives a response signal of the receiving electrodes 13 responding to the driving signal applied to the transmitting electrodes 12, and then outputs a level signal for each electrode intersection at which the transmitting electrodes 12 and the receiving electrodes 13 intersect each other. The controller 17 detects a touch position based on the level signal output from the receiver 16 and also controls operation of the transmitter 15 and the receiver 16.

In the touch screen main body 14, the transmitting electrodes 12 and the receiving electrodes 13 intersect each other in a stacked state having an insulating layer in between. At each electrode intersection where the transmitting electrodes 12 and the receiving electrodes 13 intersect, a capacitor is provided. At the time of a touch operation by a user with a pointing object such as a finger or the like, when the pointing object approaches or touches the touch surface 11, electrostatic capacitance at the electrode intersection essentially decreases in response. Thereby, it is possible to detect whether or not a touch operation is performed.

In a mutual capacitance type employed here, when a driving signal is applied to the transmitting electrodes 12, a charge-discharge current flows in the receiving electrodes 13 in response. The charge-discharge current is output from the receiving electrodes 13 as a response signal. At this point, the electrostatic capacitance at the electrode intersections changes in response to the user's touch operation. Accordingly, the response signals of the receiving electrodes 13 change. Based on the amount of the change in the response signal, a touch position is calculated. In the mutual capacitance type, a level signal is obtained by processing the response signal in the receiver 16 and is output for each electrode intersection between the transmitting electrodes 12 and the receiving electrodes 13. Thus, the mutual capacitance type enables multi-touch (multi-point detection) in which a plurality of touch positions are concurrently detected.

The transmitter 15 selects the transmitting electrodes 12 one by one and applies a driving signal to each transmitting electrode 12. The receiver 16 selects the receiving electrodes 13 one by one, performs an A/D conversion on an analog-processed response signal of the receiving electrode 13, and then outputs a level signal. The transmitter 15 and the receiver 16 act according to a synchronization signal output from the controller 17. While the transmitter 15 applies a driving signal to one of the transmitting electrodes 12, the receiver 16 selects the receiving electrodes 13 one by one and sequentially processes response signals from the receiving electrodes 13. By repeating this scanning operation for one line on all the transmitting electrodes 12 in sequence, it is possible to retrieve a level signal from each electrode intersection.

The controller 17 obtains a touch position (center coordinate of a touch area) in a predetermined calculation process that uses a level signal of each electrode intersection output from the receiver 16. In this touch position calculation, a touch position is obtained from a level signal of each of the plurality of adjacent electrode intersections (4 by 4, for example) in an X direction (placement direction of the receiving electrodes 13) and in a Y direction (placement direction of the transmitting electrodes 12) using a predetermined interpolating method (centroid method, for example). Thereby, a touch position can be detected at a higher resolution (1 mm or less, for example) than the placement pitch (10 mm, for example) of the transmitting electrodes 12 and the receiving electrodes 13.

Further, the controller 17 obtains a touch position every frame period in which reception of level signals ends for all electrode intersections across the entire surface of the touch surface 11. The controller 17 then outputs touch position information to the PC 2 in a unit of frames. Based on the touch position information in a plurality of temporally successive frames, the PC 2 generates display screen data in which touch positions are chronologically connected, and outputs the data to the display 3. In a case where touch operations are concurrently performed in a plurality of positions, touch position information for the plurality of touch positions is output in a unit of frames.

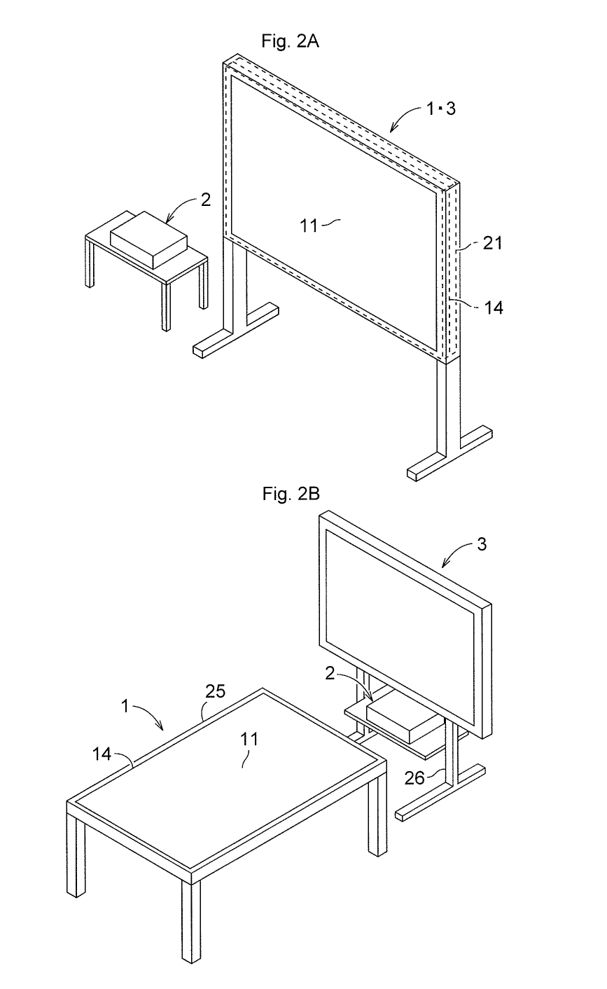

FIGS. 2A and 2B are perspective views illustrating examples of the touch screen system in use. In the example shown in FIG. 2A, the touch screen device 1 and the display 3 are integrated. The display panel main body 21 is arranged on a rear side of the touch screen main body 14. A screen of the display panel main body 21 is displayed through the touch screen main body 14. Accordingly, a user is able to perform an operation as if s/he were directly controlling the screen displayed on the display panel main body 21.

In this case, the keyboard-type input device 4 and the joystick-type input device 5 shown in FIG. 1 are detachably attached or fixed to and used on (or at any desired location of) the touch surface 11 by an appropriate fixing member such as a suction disk.

In the example shown in FIG. 2B, the touch screen device 1 is configured as a table, and to a top board 25 thereof, the touch screen main body 14 is provided. An upper surface of the top board 25 constitutes the touch surface 11 on which a user performs a touch operation. The display 3 and the PC 2 are mounted on a stand 26 that is provided on a lateral side of the touch screen device 1. Accordingly, a user is able to control the screen of the PC 2 by performing a touch operation on the touch surface 11 while looking at the screen of the display 3.

In this case, the keyboard-type input device 4 and the joystick-type input device 5 shown in FIG. 1 are used while being placed or positioned on the touch surface 11.

In addition, similar to the example shown in FIG. 2B, the touch screen device 1 may be configured as a table while the touch screen main body 14 is provided to the top board 25 and the display panel main body 21 is provided on the rear side of the touch screen main body 14. Thereby, the screen of the display panel main body 21 may be displayed on the top board 25 through the touch screen main body 14.

Moreover, while the touch screen device 1 is configured as a table similar to the example shown in FIG. 2B, the display 3 may be configured with a short-focus type projector and placed on the top board 25 of the touch screen device 1. Thereby, the touch surface 11 on the top board 25 may be used as a projection plane on which the screen of the display 3 is projected.

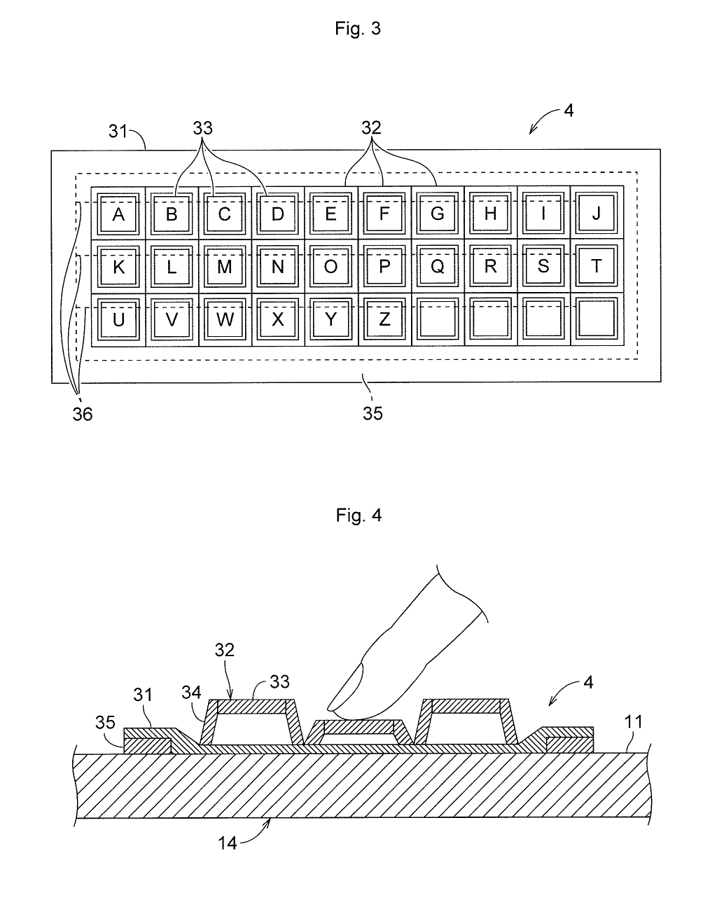

FIG. 3 is a plan view of the keyboard-type input device 4. FIG. 4 is a cross-sectional view of the keyboard-type input device 4.

As shown in FIG. 3, the keyboard-type input device 4 includes a supporter 31 and a plurality of operation keys (operation member) 32. The supporter 31 is provided on the touch surface 11 at the touch screen device 1. The plurality of operation keys 32 are arranged on the supporter 31.

As shown in FIG. 4, a conductor 33 is provided to a key top of each operation key 32. The conductor 33 is conducted with a user's body when a user's finger touches the conductor 33 at the time of operating the operation key 32.

In addition, the conductors 33 at the key tops draw closer to the touch surface 11 when a user presses down the operation keys 32. Specifically, the conductors 33 are held by holders 34 made from a flexible material. The conductors 33 remain spaced from the touch surface 11 in a default state in which the operation keys 32 are not pressed down. Accordingly, the conductors 33 are not detected on the touch screen device 1 side. When the operation keys 32 are pressed down, the holders 34 distort and the conductors 33 thus draw closer to the touch surface 11. Accordingly, the conductors 33 are detected on the touch screen device 1 side.

As described above, the operation keys 32 of the keyboard-type input device 4 mechanically operate in response to the user's press-down operation. Unlike a soft keyboard displayed on a screen, it is possible to provide operability similar to a general keyboard, thereby enhancing usability.

As shown in FIG. 3, a frame-like conductor 35 for input device identification is provided to the supporter 31. The conductor 35 causes the touch screen device 1 to recognize that the internal area of the conductor 35 is an operation area of an input device. In addition, the conductor 35 also acts to cause the touch screen device 1 to identify a type of the input device. A form or shape of the conductor 35 is different for each input device type. In this embodiment, the conductor 35 has a rectangular shape.

The conductor 35 for input device identification is electrically connected to the conductors 33 at the key tops of all the operation keys 32 through connectors 36. When a user presses down one of the operation keys 32 and a user's finger touches the conductor 33 on the key top, the conductor 35 for input device identification becomes conductively connected with a user's body. Accordingly, the conductor 35 is detected on the touch screen device 1 side.

In addition, the conductor 35 for input device identification also acts to cause the touch screen device 1 side to identify an area in which the keyboard-type input device 4 is placed. The conductor 35 is provided along an outer periphery of the supporter 31 so as to surround the conductors 33 at the key tops.

Further, the keyboard-type input device 4 does not require a circuit board or the like. Thus, in a case where the supporter 31 and the like are configured with or from a flexible material, they may be rolled up and/or folded, which enhances usability.

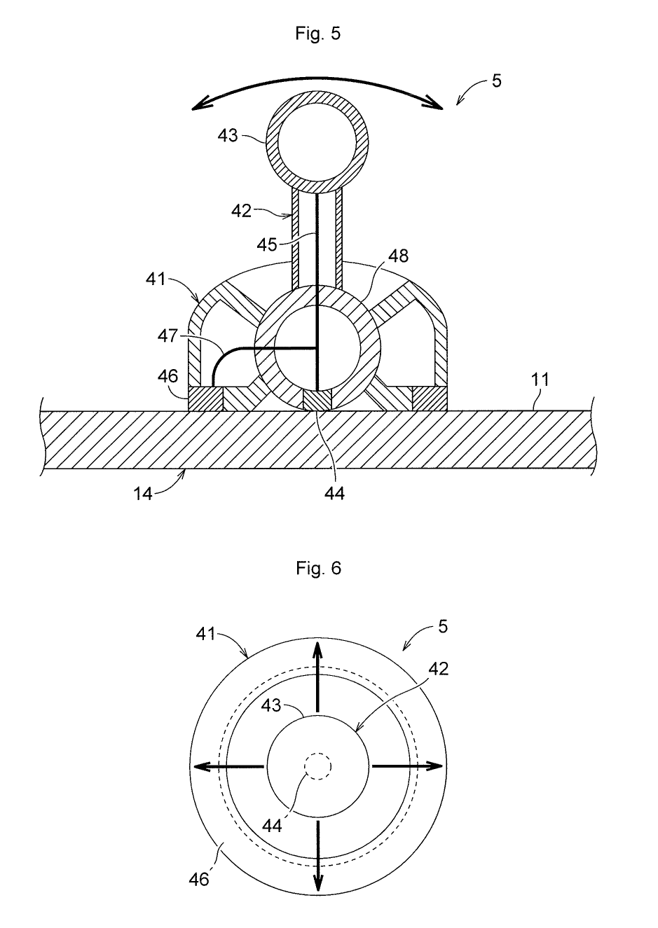

FIG. 5 is a cross-sectional view of the joystick-type input device 5. FIG. 6 is a plan view of the joystick-type input device 5.

As shown in FIG. 5, the joystick-type input device 5 includes a base (supporter) 41 and an operation lever (operation member) 42. The base 41 is placed on the touch surface 11 of the touch screen device 1. The operation lever 42 is tiltably supported by the base 41.

The operation lever 42 has a conductor 43 for being touched by a body (such as a hand of a user) on a handle at an upper end thereof. At a lower end side that is in the vicinity of the touch surface 11, a conductor 44 for operation detection is provided. The conductor 44 for operation detection moves in a direction along the touch surface 11 in conjunction with a tilt of the operation lever 42.

The conductor 43 for body touch and the conductor 44 for operation detection are electrically connected via a connector 45. When a user operates the operation lever 42 and a user's hand touches the conductor 43 of the handle, the conductor 44 for operation detection is conductively connected with a user's body. Accordingly, the conductor 44 is detected on the touch screen device 1 side.

In addition, the operation lever 42 tilts while remaining centered about a center point of a ball 48. When the operation lever 42 tilts in a predetermined direction, the conductor 44 for operation detection moves in the vicinity of the touch surface 11. This motion of the conductor 44 is detected on the touch screen device 1 side.

On a bottom surface side of the base 41, a frame-like conductor 46 for input device identification is provided. The conductor 46 causes the touch screen device 1 to recognize that the internal area of the conductor 46 is an operation area of an input device. In addition, the conductor 46 also acts to cause the touch screen device 1 to identify an input device type. A form or shape of the conductor 46 is different for each input device type. In this embodiment, the conductor 46 has a circular shape as shown in FIG. 6.

As shown in FIG. 5, the conductor 46 for input device identification is electrically connected to the conductor 43 at the handle via connectors 45 and 47. When a user operates the operation lever 42 and a user's hand touches the conductor 43 at the handle, the conductor 46 for input device identification is conducted or conductively connected with a user's body. Accordingly, the conductor 46 is detected on the touch screen device 1 side.

In addition, the conductor 46 for input device identification also acts to cause the touch screen device 1 side to identify an area in which the joystick-type input device 5 is placed. The conductor 46 for input device identification is provided along an outer periphery of the base 41 so as to surround the conductor 44 for operation detection.

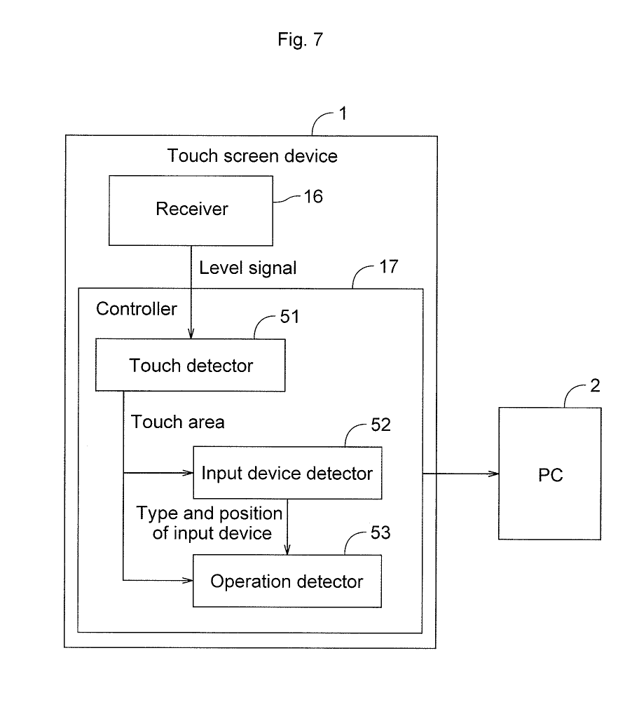

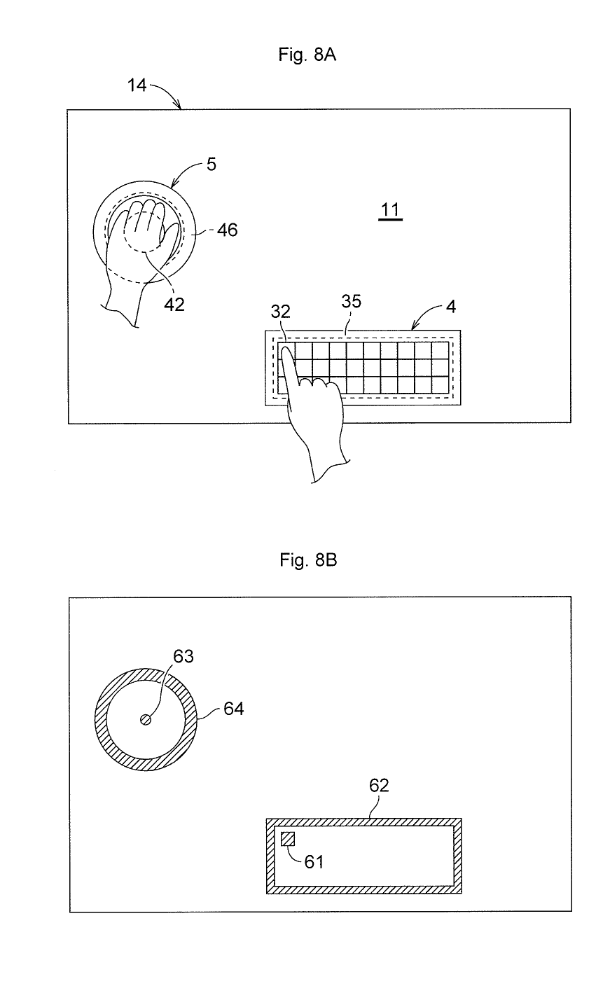

FIG. 7 is a functional block diagram illustrating a schematic configuration of the controller 17 of the touch screen device 1. FIGS. 8A and 8B are diagrams illustrating procedures to detect the input devices 4 and 5. FIG. 8A illustrates a state in which the input devices 4 and 5 are placed on the touch surface 11. FIG. 8B illustrates touch areas appearing in a touch detection effective area.

As shown in FIG. 7, the controller 17 of the touch screen device 1 includes a touch detector 51, an input device detector 52, and an operation detector 53.

The touch detector 51 detects a touch area formed by a conductor approaching the touch surface 11, based on a level signal output from the receiver 16. In this embodiment, when a user performs a touch operation on the touch surface 11 with a pointing object (a finger, a stylus, and the like), a touch area associated with the pointing object is detected. In addition, by placing and operating the input devices 4 and 5 on the touch surface 11, touch areas associated with the conductors 33, 35, 44, and 46 of the input devices 4 and 5 are detected.

The input device detector 52 detects placements of the input devices 4 and 5 on the touch surface 11, based on forms of touch areas that the touch detector 51 has obtained or detected. In this embodiment, the input device detector 52 identifies types of the input devices 4 and 5 placed on the touch surface 11 and also obtains placement positions of the input devices 4 and 5.

When a user places the keyboard-type input device 4 on the touch surface 11 and presses down the operation key 32 thereof as shown in FIG. 8A, a touch area 61 is detected in the position of the conductor 33 (see FIG. 3) at the key top where a finger touches, as shown in FIG. 8B. Further, a rectangular touch area 62 is detected in the position of the frame-like conductor 35 conducted with the conductor 33 at the key top. Because of the rectangular touch area 62, it is known that the keyboard-type input device 4 has been placed on the touch surface 11.

In addition, when a user places the joystick-type input device 5 on the touch surface 11 and operates the operation lever 42 thereof as shown in FIG. 8A, a touch area 63 is detected, as shown in FIG. 8B, by the position of the conductor 44 for operation detection (see FIG. 6) that is conducted with the conductor 43 (see FIG. 5) of the handle that a user's hand touches. Further, a circular touch area 64 is detected in the position of the frame-like conductor 46 conducted with the conductor 43 at the handle. Because of the circular touch area 64, it is known that the joystick-type input device 5 has been placed on the touch surface 11.

As described above, when the types of the input devices 4 and 5 placed on the touch surface 11 are identified, placement positions of the input devices are obtained based on the positions of the touch areas 62 and 64 associated with the frame-like conductors 35 and 46, respectively. Identification information indicating the types of the input devices and position information regarding the placement positions of the input devices are then output from the input device detector 52 to the operation detector 53, as shown in FIG. 7.

The operation detector 53 detects an operating state of the input devices 4 and 5 based on the types and placement positions of the input devices obtained from the input device detector 52 and changes of the touch areas detected by the touch detector 51.

As shown in FIGS. 8A and 8B, in the case of the keyboard-type input device 4, when a user presses down the operation key 32, the touch area 61 associated with the conductor 33 at the key top appears on the internal side of the rectangular touch area 62 associated with the frame-like conductor 35. The touch area 61 changes its position depending on which operation key 32 is pressed down. Accordingly, it is possible to identify which operation key 32 is pressed down based on a positional relationship of the touch area 61 relative to the touch area 62.

In the case of the joystick-type input device 5, when a user operates the operation lever 42, the touch area 63 associated with the conductor 44 for operation detection appears on the internal side of the circular touch area 64 associated with the frame-like conductor 46. The touch area 63 changes its position in conjunction with an operation of the operation lever 42. Accordingly, it is possible to identify an operating state (tilt direction and tilt angle) of the operation lever 42 based on a positional relationship of the touch area 63 relative to the touch area 64.

After the operating states of the input devices 4 and 5 are detected by the operation detector 53 as described above, identification information (code assigned to each operation key, for example) of the pressed operation key 32 is output from the operation detector 53 in the case of the keyboard-type input device 4, and information regarding a tilt direction and a tilt angle (amount of operation in the X direction and the Y direction, for example) of the operation lever 42 is output from the operation detector 53 in the case of the joystick-type input device 5.

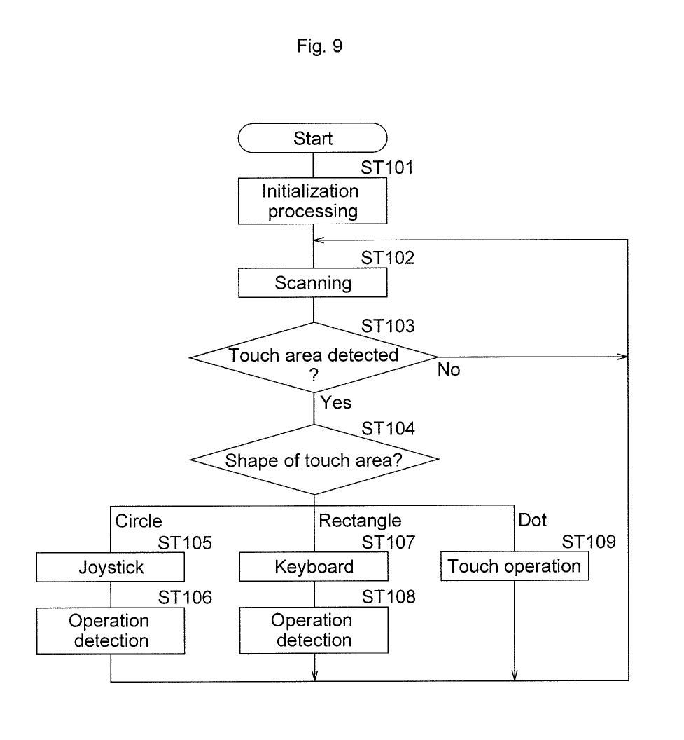

FIG. 9 is a flowchart illustrating processing steps performed in the controller 17 of the touch screen device 1. First, when the touch screen device 1 is powered on, initialization processing is performed (ST101). In this initialization processing, an initial value of a level signal, that is, a level signal in a non-touch state in which a touch operation is not performed, is obtained for each electrode intersection.

Next, a scanning operation for one frame is performed (ST102) to obtain a level signal for each electrode intersection. Then, the touch detector 51 determines whether or not there is a touch area (ST103) by comparing the obtained level signals with the initial values obtained during the initialization processing (ST101). In a case where a touch area is detected at this point (Yes in ST103), the input device detector 52 performs processing to detect an input device based on a shape of the touch area (ST104).

In a case where the touch area is in a circular shape having a predetermined size, the joystick-type input device 5 is determined to have been placed on the touch surface 11 (ST105). The operation detector 53 then performs processing to detect an operating state of the operation lever 42 based on a movement of the touch area 63 associated with the conductor 44 of the joystick-type input device 5 (ST106). Information regarding the operating state is then output to the PC 2.

In a case where the touch area is in a rectangular shape having a predetermined size, the keyboard-type input device 4 is determined to have been placed on the touch surface 11 (ST107). The operation detector 53 then performs processing to detect an operating state of the operation keys 32 based on the position of the touch area 61 associated with the conductor 33 at the key top of the keyboard-type input device 4 (ST108). Information regarding the operating state is then output to the PC 2.

Further, in a case where the touch area is a dot (corresponding to a size of a finger or a stylus), it is determined that a regular touch operation has been performed (ST109). The information regarding the touch position is then output to the PC 2.

As described above, by causing the touch screen device 1 to detect the conductors 35 and 46 for input device identification provided to the input devices 4 and 5, it is possible to identify the types of the input devices on the touch screen device 1 side. Accordingly, it is possible for the touch screen device 1 side to accurately detect operating states of operation members (the operation keys 32 and the operation lever 42) that are different according to the types of the input devices 4 and 5. In addition, it is possible to detect placement positions of the input devices 4 and 5 on the touch surface 11 with the conductors 35 and 46 for input device identification.

Accordingly, the input devices 4 and 5 can be placed and used in desired positions on the touch surface 11 of the touch screen device 1. Particularly in a configuration in which the display panel main body 21 is provided on the rear side of the touch screen main body 14 such that a screen is displayed to overlap with the touch surface 11, the input devices 4 and 5 can be placed and used in positions where the input devices 4 and 5 do not block any critical display image. In addition, it is possible to interchangeably use a plurality of the input devices 4 and 5 as needed. Furthermore, it is also possible to simultaneously use the plurality of input devices 4 and 5. Thereby, usability for a user is improved.

In particular, the conductors 33 and 43 for body touch, which a user's body touches when the user operates the operation members (the operation keys 32 and the operation lever 42), are electrically connected to the conductors 35 and 46 for input device identification. Accordingly, in response to a user's operation on the operation members, the conductors 35 and 46 for input device identification are conducted with a user's body through the conductors 33 and 43 for body touch. It is thus possible for the touch screen device 1 side to detect the conductors 35 and 46 for input device identification without any special operation by a user, thereby improving usability for the user.

Further, in the case of the keyboard-type input device 4, the conductor 33 at the key top acts as a conductor for body touch and also as a conductor for operation detection. In the case of the joystick-type input device 5, the conductor 43 for body touch and the conductor 44 for operation detection are electrically connected. Accordingly, a user needs to operate only the operation members (the operation keys 32 and the operation lever 42) in order to have a conductor for operation detection conduct with the user's body, thereby simplifying operation.

Further, since the conductors 35 and 46 for input device identification are provided so as to surround the operation members (the operation keys 32 and the operation lever 42), it is possible to identify areas in which the input devices 4 and 5 are placed based on detection results of the conductors 35 and 46 for input device identification. Accordingly, it is possible to easily and accurately detect the operation of the operation members on the touch screen device 1 side.

Further, touch areas associated with the conductors 33 and 44 for operation detection are always located on the internal side of the conductors 35 and 46 for input device identification. In a case where touch areas are detected on the external side in the vicinity of the touch areas associated with the conductors 35 and 46 for input device identification, it is possible to determine that a user touched the touch surface 11 by mistake while operating the input devices 4 and 5. Accordingly, it is possible to prevent a false detection by invalidating the touch area detected on the external side in the vicinity of the touch areas associated with the conductors 35 and 46 for input device identification.

### Second Embodiment

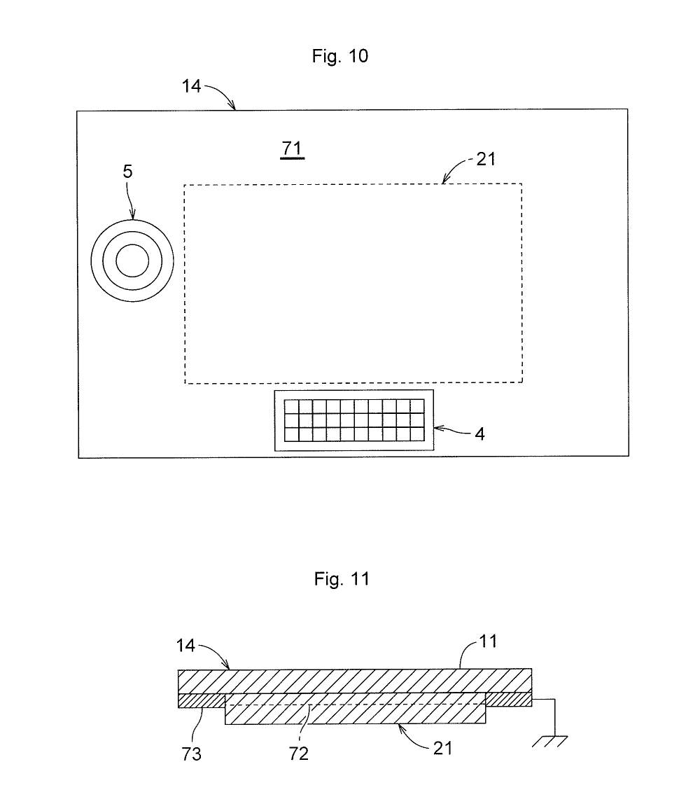

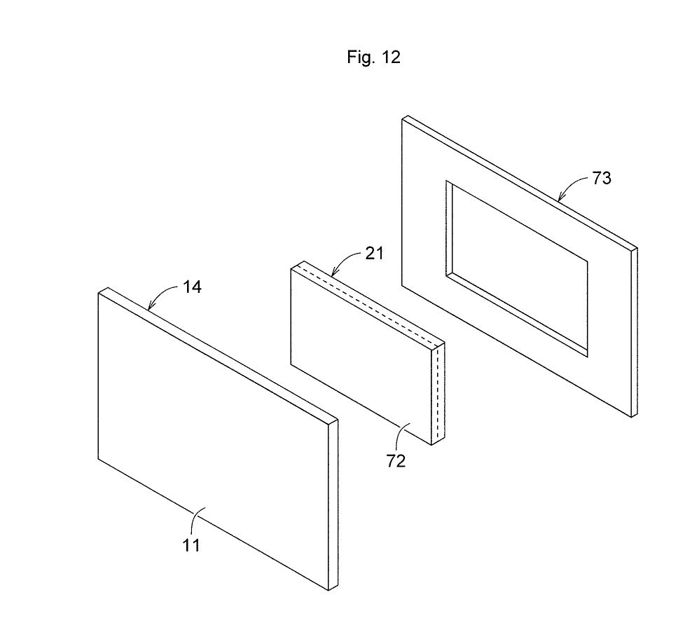

FIG. 10 is a plan view of a touch screen system according to a second embodiment. FIG. 11 is a cross-sectional view of the touch screen main body 14, the display panel main body 21, and electrode planes 72 and 73. FIG. 12 is an exploded perspective view of the touch screen main body 14, the display panel main body 21, and the electrode plane 73. Particulars not specifically mentioned here are the same as the first embodiment.

In the second embodiment, as shown in FIG. 10, the touch screen main body 14 is configured to be larger than the display panel main body 21. A non-display area 71 is provided outside the display panel main body 21 in the touch screen main body 14. In the non-display area 71, the keyboard-type input device 4 and the joystick-type input device 5 are placed.

Accordingly, it is possible to place the keyboard-type input device 4 and the joystick-type input device 5 so as not to overlap with a screen of the display panel main body 21.

As shown in FIG. 11, the electrode plane 72 is provided to the display panel main body 21. The electrode plane 72 is a mesh electrode in the case of a plasma display panel, and a non-mesh transparent electrode in the case of a liquid crystal display panel. With the display panel main body 21 being provided along the rear side of the touch screen main body 14, the electrode plane 72 forms a capacitive coupling between the transmitting electrodes 12 and the receiving electrodes 13 of the touch screen main body 14. Accordingly, electric properties vary greatly between an area where the display panel main body 21 is provided and an area where the display panel main body 21 is not provided.

Thus, in the present second embodiment, as shown in FIGS. 11 and 12, the electrode plane 73 having electric properties similar to the electrode plane 72 of the display panel main body 21 is provided in the area where the display panel main body 21 is not provided on the rear side of the touch screen main body 14. Accordingly, it is possible to avoid a circumstance where electric properties greatly vary in the touch screen main body 14 between an area where the display panel main body 21 is provided and an area where the display panel main body 21 is not provided. It is thus possible to accurately and stably perform touch detection.

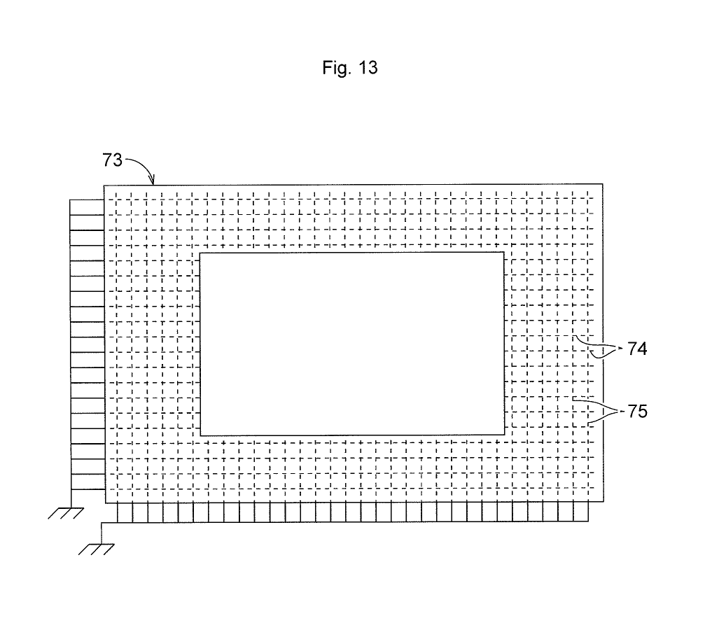

FIG. 13 is a plan view of the electrode plane 73. The electrode plane 73 may have the same configuration as that of the touch screen main body 14, in which electrodes 74 and 75 configured with linear conductors are arranged in a grid pattern with a portion corresponding to the display panel main body 21 being cut out. All the electrodes 74 and 75 are grounded.

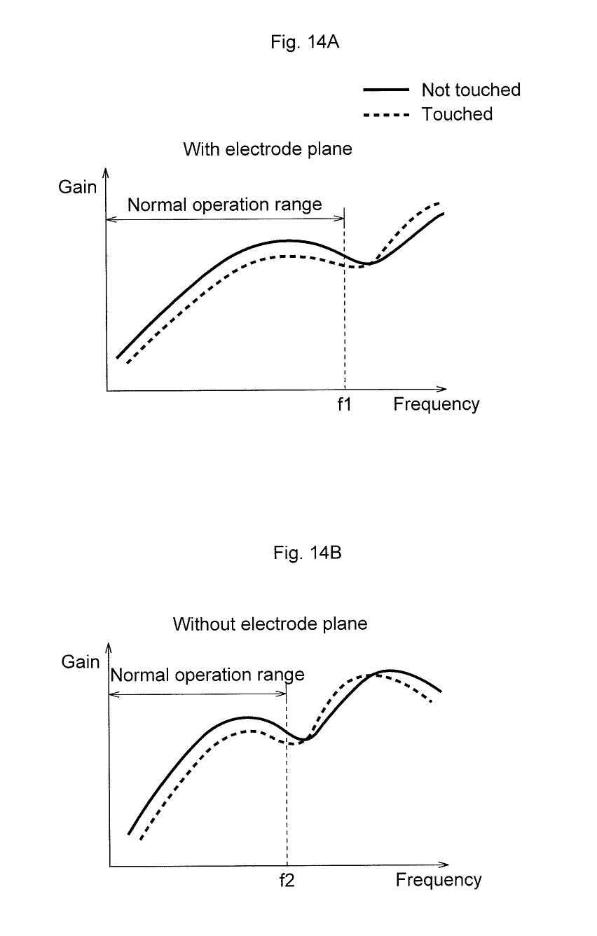

FIGS. 14A and 14B are diagrams illustrating frequency characteristics of output signals of the receiving electrodes 13. FIG. 14A illustrates a case with the electrode planes 72 and 73. FIG. 14B illustrates a case without the electrode plane 73. In this embodiment, while a driving signal is applied to one of the transmitting electrodes 12, a signal output from one of the receiving electrodes 13 is received. At this time, a signal level is measured while a frequency of the driving signal is changed.

As described above, in the present touch screen device 1, a touch operation is detected based on the amount of change in a signal level associated with presence or absence of the touch operation. In order to accurately detect a touch operation, it is necessary to configure the amount of change in the signal level associated with the presence or absence of a touch operation to be large.

As shown in FIG. 14B, in a state without the electrode plane 73, specifically, in a state where the electrode plane 73 is not provided while the display panel main body 21 is provided on the rear side of the touch screen main body 14, a region of frequency lower than a frequency f2 is within a normal operation range. In a case where the frequency of a driving signal is higher than that, the amount of change in a signal level is too small. In addition, a circumstance arises in which a signal level is reversed. Thus, it is impossible to perform normal touch detection.

On the other hand, as shown in FIG. 14A, in a state with the electrode planes 72 and 73, specifically, in a state where the display panel main body 21 and the electrode plane 73 are provided on the rear side of the touch screen main body 14, a normal operation range is expanded to a high frequency side. Accordingly, it becomes possible to perform normal touch detection up to a frequency f1 that is higher than the frequency f2 (f1>f2), the frequency f2 being an upper limit for the case without the electrode plane 73. When an operation is possible at a high frequency as described above, time required to scan one frame is reduced. Thus, it is possible to increase a frame rate and achieve higher speeds.

In particular, when the size of the touch screen main body 14 is increased, accuracy in touch detection decreases unless the frequency of a driving signal is lowered. It is thus impossible to raise the frequency of a driving signal, which tends to lower a frame rate. As described above, however, by providing the display panel main body 21 on the rear side of the touch screen main body 14 as well as providing the electrode plane 73 in the area where the display panel main body 21 is not provided, it is possible to expand the normal operation range to the high frequency side. Thus, it is possible to increase a frame rate and achieve higher speeds.

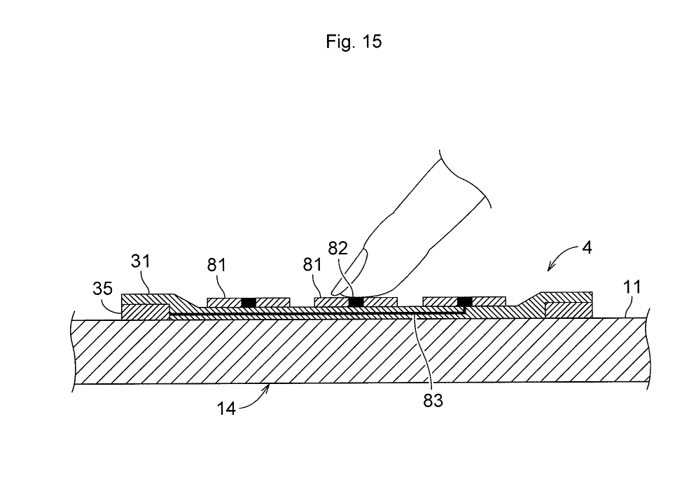

FIG. 15 is a cross-sectional view of another example of the keyboard-type input device 4. In this example, operation keys 81 are provided on the supporter 31. The operation keys 81 are each provided with a conductor 82 for body touch that comes in contact with a part of a finger when a user presses down the operation key 81. The conductors 82 for body touch are electrically connected to the frame-like conductor 35 for input device identification via a connector 83.

In the example shown in FIG. 4, the position of the conductor 33 at the key tops relative to the touch surface 11 changes according to a user's pressing-down operation on the operation keys 32. In the example here (FIG. 15), the operation keys 81 do not move even when pressed. In addition, there is no conductor for operation detection that causes the touch screen device 1 side to detect a user's operation. When a user presses the operation keys 81, a finger approaching the touch surface 11 is directly detected on the touch screen device 1 side.

Further, when the user presses the operation keys 81 and the user's finger touches the conductors 82, the frame-like conductor 35 is conducted with a user's body. Thereby, the frame-like conductor 35 is detected on the touch screen device 1 side. At this time, all the conductors 82 are electrically connected via the connector 83 and the conductor 35. Accordingly, the conductors 82 of unpressed operation keys 81 are also detected on the touch screen device 1 side. In the position of a pressed operation key 81, however, a touch area is detected in the size of a fingertip. In addition, the touch area has a larger area than that of the conductor 82. Thereby, it is possible to identify which operation key 81 has been pressed.

Furthermore, although the keyboard-type input device 4 and the joystick-type input device 5 are shown as examples of input devices for the touch screen in the present embodiments, an input device integrally combining these devices may be used. Of course, other input types can also be utilized instead of or together with the input devices 4 and 5. Further, different types of keyboard-type input devices and joystick-type input devices can also be utilized.

Furthermore, in the present embodiments, as shown in FIG. 4, the conductors 33 at the key tops of the keyboard-type input device 4 each have a plate shape, and is configured to act as a conductor for body touch as well as a conductor for operation detection. However, it is also possible to configure a conductor for body touch and a conductor for operation detection as separate members.

Furthermore, in the present embodiments, as shown in FIGS. 3 and 6, the conductors 35 and 46 for input device identification have forms that differ for each type of the input devices 4 and 5 and are configured to have a rectangular shape in the case of the keyboard-type input device 4 and a circular shape in the case of the joystick-type input device 5. However, the form of the conductor for input device identification in the present invention is not limited to the above forms. As long as an input device can be identified based on a form, such as shape, number, size, or the like, of a member that constitutes the conductor for input device identification, the conductor for input device identification may be configured with only one member. Further, the conductor for input device identification may be a combination of a plurality of members, for example. In this case, input devices are identified based on relative placement positions of the plurality of members.

Furthermore, in the present embodiments, as shown in FIGS. 3 and 5, the conductors 33 and 43 for body touch that a user's body touches when operating the operation members (the operation keys 32 and the operation lever 42) are electrically connected to the conductors 35 and 46 for input device identification and to the conductors 33 and 43 for operation detection. The conductors 35 and 46 for input device identification and the conductor 33 and 43 for operation detection are configured to simultaneously conduct with a user's body in response to a user's operation on the operation member. However, another configuration is also possible in which a conductor for body touch is separately connected to each of a conductor for input device identification and a conductor for operation detection. In such a case, a user touches the conductor for body touch that is connected to the conductor for input device identification, prior to an operation on the operation members. Thereby, it is possible to cause the touch screen device 1 to identify an input device.

Furthermore, in the present embodiments, as shown in FIG. 13, the electrode plane 73 is configured with the electrodes 74 and 75 that are configured with linear conductors and are arranged in a grid pattern. However, electrodes provided to an electrode plane may be configured with a non-mesh conductor.

An input device for a touch screen and a touch screen system having the same according to the present invention have an effect of enhancing usability for a user and are useful as an input device for a touch screen and a touch screen system having the same in which the input device is placed and used on a touch surface of a touch screen device.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An input device for a touch screen, comprising:
a supporter provided on a touch surface of a touch screen device; and
an operation member for an operation by a user, the operation member being supported by the supporter; wherein
the operation member includes a body touch conductor that comes into contact with the user's body when the user operates the operation member;
the supporter includes an input device identification conductor that indicates a touch area where the input device is placed on the touch surface; and
the body touch conductor is electrically connected to the input device identification conductor so that the touch screen device detects the input device identification conductor when the user operates the operation member.

2. The input device for the touch screen according to claim 1, wherein the operation member has an operation detection conductor causing the touch screen device to detect the operation by the user; and
the operation detection conductor is electrically connected to the body touch conductor.

3. The input device for the touch screen according to claim 1, wherein the input device identification conductor is provided so as to surround the operation member.

4. The input device for the touch screen according to claim 3, wherein the input device identification conductor is provided along an outer periphery of the supporter.

5. The input device for the touch screen according to claim 4, wherein a form of the input device identification conductor is different for each input device type.

6. The input device for the touch screen according to claim 2, wherein the operation member is configured with a plurality of operation keys;
the operation keys each include the operation detection conductor; and
the operation detection conductor moves closer to the touch surface when the operation key is depressed.

7. The input device for the touch screen according to claim 6, wherein the operation detection conductor is supported by a holder of a flexible material.

8. The input device for the touch screen according to claim 2, wherein the operation member is configured with an operation lever that is tiltably supported on the supporter;
the body touch conductor is provided at a handle of the operation lever and the operation detection conductor on a side close to the touch surface, the operation detection conductor moving in a direction along the touch surface in conjunction with tilting of the operation lever; and
the body touch conductor and the operation detection conductor are electrically connected.

9. A touch screen system comprising:
the input device for the touch screen according to claim 1; and
a touch screen device having a touch surface on which a touch operation by a user is performed and on which the input device is provided, wherein
the touch screen device comprises:
a touch detector detecting a touch area where the input device identification conductor is positioned on the touch surface; and
an input device detector obtaining a position of the input device, based on the touch area detected by the touch detector.

10. The touch screen system according to claim 9, wherein the input device detector identifies a type of the input device, based on a shape of the touch area.

11. The touch screen system according to claim 9, wherein the touch screen device further comprises an operation detector detecting an operating state of the input device, based on a detection result from the input device detector and a change in the touch area detected by the touch detector.

12. The touch screen system according to claim 9, further comprising an image display device in which a display panel main body is provided on a rear side of a touch screen main body of the touch screen device

13. The touch screen system according to claim 12, wherein
the touch screen main body is configured to be larger than the display panel main body; and
the input device is provided in an area of the touch screen main body provided outside a display area of the display panel main body.

14. The touch screen system according to claim 13, wherein an electrode plane is provided in an area where the display panel main body is not present on the rear side of the touch screen main body.

15. The touch screen system according to claim 14, wherein the electrode plane comprises linear conductors comprising electrodes arranged in a grid pattern.

16. The touch screen system according to claim 15, wherein each of the linear conductors is grounded.

17. The input device according to claim 1, wherein the supporter and the operation members are flexible, and the input device is configured to be rolled-up or folded.

18. The input device according to claim 1, wherein the supporter is provided on the touch surface of the touch screen device by being detachably secured to the touch surface.

19. The input device according to claim 18, wherein the supporter is configured to be selectively attached on any part of the touch surface of the touch screen device.

20. The touch screen system according to claim 9, further including a plurality of input devices of different types.
